(19) United States
(12) Patent Application Publication
(10) Pub. No.: US 2003/0126011 A1
(43) Pub. Date: Jul. 3, 2003

(54) Systems and methods for issuing partnership checks to a customer having a financial account

(75) Inventors: Jennifer Bryman, Richmond, VA (US); Femi Allen, Washington, DC (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/032,469

(22) Filed: Jan. 2, 2002

(51) Int. Cl. G06F 17/60

(52) U.S. Cl. 705/14

(57) ABSTRACT

Systems and methods are provided for issuing partnership checks to customers. The disclosed systems and methods include analyzing a set of factors for a group of merchants to identify merchant(s), creating a partnership check such that it is redeemable with the identified merchant(s), and issuing the partnership checks to customers for use in financial transactions with the identified merchant(s). Further, in accordance with the disclosed systems and methods, value sharing relationships are formed between one or more issuers and merchants for the purposes of issuing partnership checks to customers with a financial account.

### BACKGROUND THE INVENTION

I. Field of the Invention

The present invention generally relates to systems and methods for issuing financial instruments to customers for making financial transactions. More particularly, the invention relates to systems and methods for issuing financial instruments, such as partnership checks, to customers having a financial account.

II. Background Information

Customers must physically carry cash to have it available to make a purchase. Bank checks, on the other hand, are a financial instrument that allow customers to make purchases without having to physically carry cash. Rather, a customer's money can be held by a financial institution, such as a bank. The bank agrees to safely hold the customer's money in an account and to deduct the amount of the check as purchases are made. Checks thus give customers access to their money by simply writing the check. However, the advantage of checks can be offset by the reduced liquidity as compared to cash.

Checks also present disadvantages to their recipients in the form of increased paperwork, delays in obtaining the actual funds, and possible fraud. For instance, merchants who receive checks must do additional paperwork and accounting to keep track of them. In addition, merchants do not have immediate access to the actual funds because the check must first be sent to an authenticating authority, such as a bank, for confirmation. During this time, the merchant must wait for the authenticating authority to collect the check amount from the customer's bank and to forward the money back to the merchant. Additionally, checks increase the likelihood of fraud because the purchaser's signature can be forged. The purchaser can also write a check for more money than is in the purchaser's bank account. Merchants thus assume greater risk when accepting checks as compared to cash. In an effort to reduce their risk, merchants often require multiple forms of identification from the customer writing a check, which slows down the overall transaction, and burdens both parties. Further, some merchants may not accept checks at all.

Credit cards were designed to give customers the flexibility of not having to carry cash while at the same time the benefit of not having money tied up in a bank account. With credit cards, customers buy goods or services on credit. Although a merchant may extend the credit, usually the credit is extended by a financial institution. In the latter case, the financial institution creates an account for the customer and charges the customer interest on the account balance generated as the customer makes purchases using the credit card. The financial institution also acts as a guarantor of the customer by providing a guarantee to the merchant that payment will be received. The interest charged to the customer represents a payment to the credit card company for its services and assumption of risk, and is usually determined based on a customer's credit rating. Typically, the financial institution can use a risk verses return analysis to determine the interest rate and credit limit to extend to a card holder.

Convenience checks issued by credit card companies emerged as an offshoot of credit cards. Convenience checks can be pre-printed for a predetermined dollar amount and issued to specific customers, such as credit card customers. When cashed, the dollar amount of the convenience check is credited to the outstanding account balance of the customer. Convenience checks thus provide the customer with a quick cash loan associated with the credit card account.

Thus, each of these different financial instruments have their own advantages, disadvantages, and limitations. Occasionally, merchants may offer discounts to customers who use cash. Additionally, to stimulate use, financial institutions may offer cash rebates or awards based on purchases made with a credit card. However, neither form of payment provides built-in incentives for the customer to make purchases with a particular merchant and/or use a particular form of payment. In addition, neither form of payment provide customers with information on which merchants offer particular good or services of interest to that customer.

### SUMMARY OF THE INVENTION

In accordance with an embodiment of the invention, a method is provided for issuing partnership checks, wherein the method includes: analyzing a set of factors of a group of merchants to identify at least one merchant for associating with a partnership check that is to be sent to a customer; creating the partnership check such that the partnership check is redeemable with the merchant; and sending the created partnership check to a customer.

In accordance with another embodiment of the invention, the method may also include: determining whether the customer meets a set of predetermined qualification criteria; and sending the created partnership check to the customer if the customer meets the predetermined qualification criteria.

According to yet another embodiment of the invention, there is a method for providing partnership checks for use by customers, wherein the partnership checks are issued by an issuer. The method includes: forming a value sharing relationship with at least one merchant; generating partnership checks that are redeemable with the at least one merchant, each of the partnership checks including printed indicia that is indicative of a predetermined transaction amount; and providing an incentive with each partnership check, wherein the incentive extends to customers that use the partnership check.

In other embodiments of the invention, there is a method for providing partnership checks, wherein the method includes: generating a list of prospective merchants; analyzing the list of prospective merchants based on a set of merchant qualification criteria to form a set of merchants; generating a list of prospective customers; analyzing the list of prospective customers based on a set of customer qualification criteria to form a set of customers; and issuing partnership checks to the set of customers, wherein each of the partnership checks includes an incentive that extends to customers that use the partnership check as part of a financial transaction with the set of merchants.

According to still other embodiments of the invention, there is a partnership check system comprising: means for analyzing a group of merchants based on a set of merchant qualification criteria to identify a merchant for associating with a partnership check; means for creating the partnership check such that the partnership check is redeemable with the identified merchant; and means of sending the created partnership check to a set of customers.

Additional features and aspects of embodiments of the invention will be set forth in part in the description which follows, and in part will be obvious from the description, or may be learned by practice of the invention. The features and aspects of embodiments of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various features and aspects of embodiments of the invention. In the drawings:

FIG. 1 is a diagram of an exemplary system environment, consistent with embodiments of the invention;

FIG. 2 is an exemplary partnership check, in accordance with an embodiment of the invention;

FIG. 3 is an exemplary flowchart for issuing partnership checks, in accordance with another embodiment of the invention;

FIG. 4 is an exemplary flowchart for creating a value sharing relationship, consistent with still another embodiment of the invention;

FIG. 5 is an exemplary flowchart for choosing customers to issue partnership checks, in accordance with an embodiment of the invention; and

FIG. 6 an exemplary flowchart for making a transaction using an exemplary partnership check, consistent an embodiment of the invention.

### DESCRIPTION OF THE EMBODIMENTS

Embodiments of the present invention will now be described with reference to the accompanying drawings. Wherever possible, the same reference numbers will be used throughout the drawings to refer to the same or like parts.

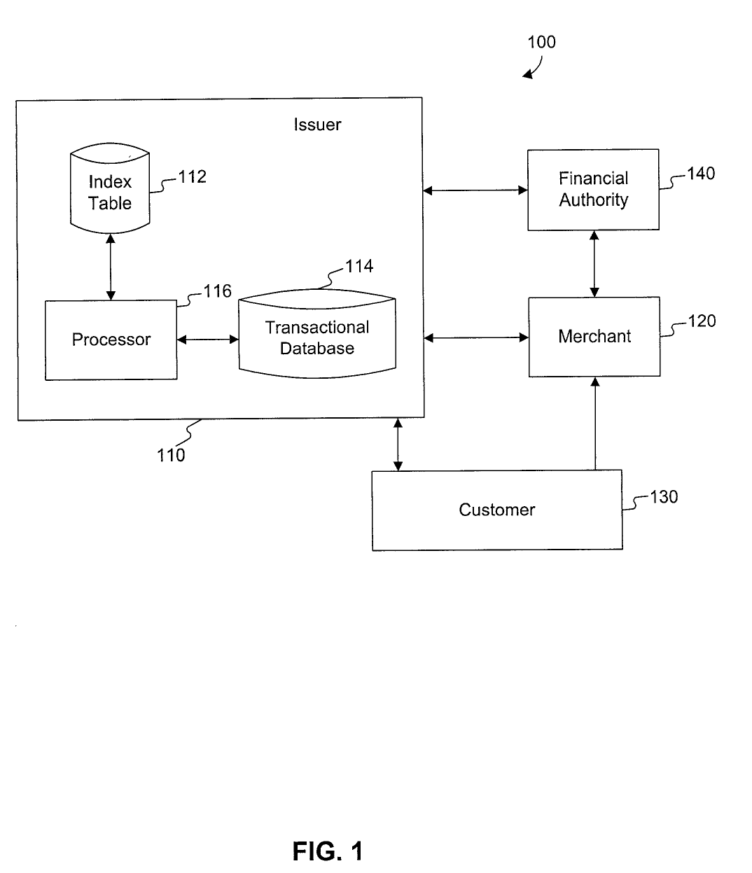

FIG. 1 illustrates an exemplary system environment 100, consistent with embodiments of the present invention. System environment 100 includes an issuer 110 that communicates with a merchant 120, a customer 130, and a financial authority 140. Communication between issuer 110 and the other components or entities of system environment 100 may be achieved through suitable communication channels 150, including electronic or on-line communication channels and physical or face-to-face communication channels. Examples of electronic or on-line communication channels include wired or wireless networks, such as an intranet, the Internet, a public telephone network, and a wireless phone network. Examples of physical or face-to-face communication channels include store-front or kiosk locations, as well as standard mail or courier systems and advertising arrangements. As illustrated in FIG. 1, similar communication channels 150 may also be provided between merchant 120, customer 130 and financial authority 140 to facilitate communication between these individual components.

In an embodiment of the present invention, issuer 110 may be a financial institution that extends credit, such as a bank, credit card company, credit union, retailer, or another type of financial institution. Further, merchant 120 may be a retailer, wholesaler, provider of goods or services, an on-line merchant or another type of merchant. Customer 130 may be an individual, a family or group of persons, a company or any other entity. In an embodiment of the present invention, Financial Authority 140 may be the Federal Reserve Bank of the United States, issuer's 110 bank, merchant's 120 bank, an intermediary bank, or any other agreed upon financial agency capable of approving and routing financial instruments. Although FIG. 1 illustrates one merchant 120, one customer 130, and one financial authority 140, it will be appreciated that any number of merchants, customers, and financial authorities may be provided.

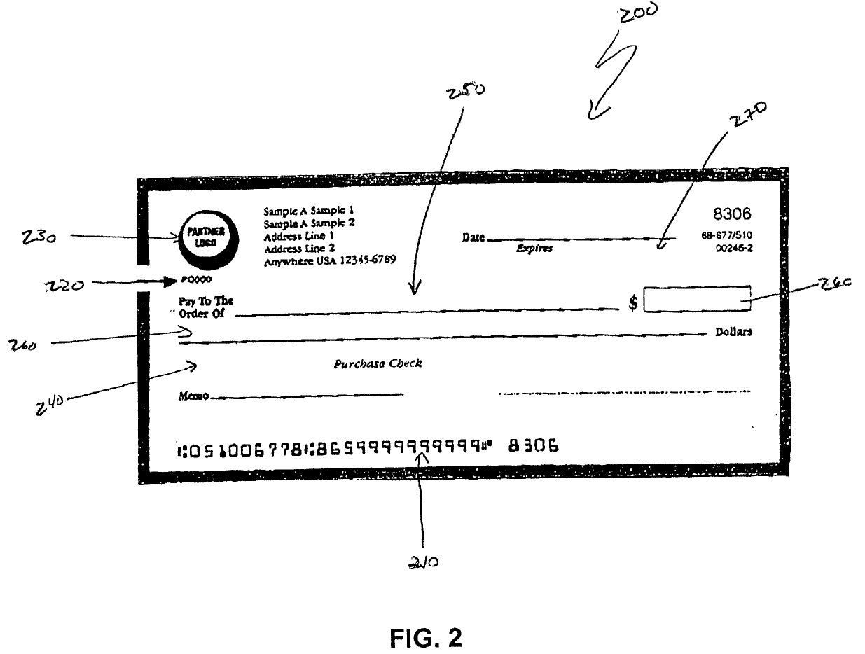

In system environment 100 of FIG. 1, issuer 110 may conduct transactions and establish a value sharing relationship (VSR) with one or more merchants 120 to create a partnership to issue partnership checks (PC) to customers 130. As used herein, the term VSR refers to any relationship structured between one or more issuers and merchants for issuing PCs to customers and sharing in the value or return related to issuance and/or use of those PCs. Further, the term PC, as used herein, refers to any financial instrument issued to customers for conducting financial transactions with one or more merchants that are part of a VSR. An exemplary PC is further described below with reference to FIG. 2.

To issue PCs to new customers, issuer 110 can extend credit and/or create a financial account for a customer 130 so that the customer can make transactions using a PC. The financial account can have an associated account number for tracking the PC to each customer's 130 account. If the customer 130 is an existing customer of issuer 110, then issuer 110 may evaluate each customer's 130 account to determine if the account is in good status and/or determine if additional credit should be extended to the customer to permit financial transactions to be performed using a PC.

Consistent with embodiments of the present invention, customer 130 can use PCs by transacting with one or more merchants 120 to purchase goods or services using a PC. When customer 130 uses a PC, the customer's financial account is affected. For example, after accepting a PC, merchant 120 forwards the PC to a financial authority 140 for authentication. Financial authority 140 evaluates the PC and transmits the finding to both merchant 120 and issuer 110. If the PC authenticated, the transaction is approved and issuer 110 posts the transaction amount to the financial account of customer 130.

As further illustrated in FIG. 1, issuer 110 can maintain index table 112 in a database or memory device. Index table 112 can contain a stored list of all customers of issuer 110. In addition, index table 112 can also contain a stored list of the merchants with whom issuer 110 has transacted, the merchants with whom customer 130 has transacted, and the merchants issuer 110 has created VSRs.

Issuer 110 can also maintain a transactional database 114 in a database or memory device in order to store financial information about each customer 130. For instance, transactional database 114 can store information about the customer's account balance, spending history, liabilities, and credit rating. Transactional database 114 may also store information about each merchant 120 with which the customer has transacted. Further, transactional database 114 can store information about each customer's 130 purchases, such as what, when, what price, and from whom a purchase was made.

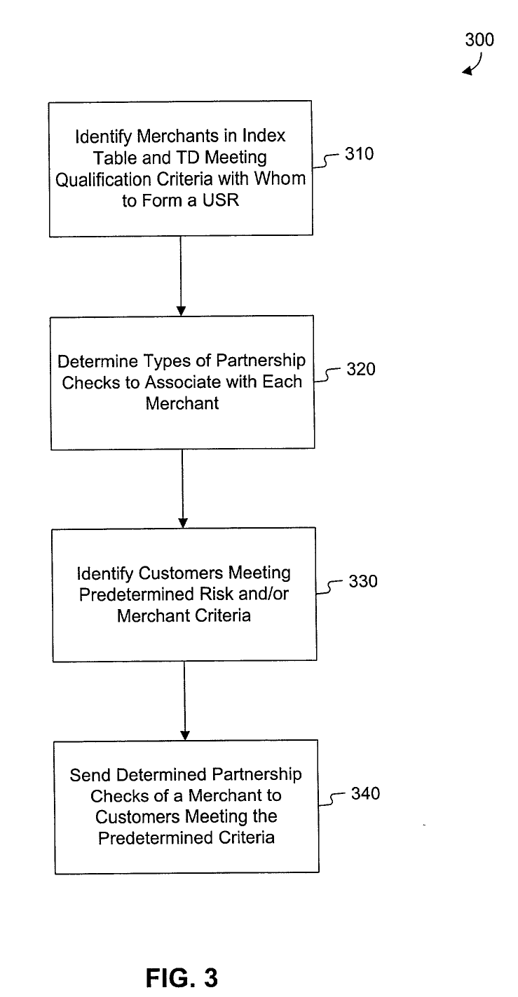

As further illustrated in FIG. 1, a processor 116 can be used to compare or analyze information from index table 112 and transactional database 114. Processor 116 may also be configured to analyze information concerning customers or merchants from external databases or sources (not illustrated in FIG. 1). Processor 116 can be implemented through any computing-based platform (such as a computer, workstation or server) and aid issuer 110 in determining which merchants to structure VSRs with, what types of PC to create and which customers to issue PCs to. Exemplary features and processes that may be implemented with processor 116 are further described below with reference to FIGS. 3-5.

Consistent with embodiments of the present invention, many types of PCs are possible. In certain embodiments, for example, the PC is structured such that it is only redeemable with a particular merchant or set of merchants. If a merchant has multiple locations, the PCs may be valid at any of the merchant's locations and, thus, PCs need not be geographically limited. In addition, consistent with other embodiments of the invention, the PC can be pre-approved and the merchant need not perform any additional authentication or processing of the PC to complete the transaction. As further disclosed herein, PCs also may be structured to provide incentives (such as financial incentives) to encourage their use by customers.

FIG. 2 illustrates an exemplary PC 200, consistent with embodiments of the invention. In FIG. 2, PC 200 is implemented as a financial instrument that resembles a check. This check may be issued in printed form (as with conventional checks) and/or issued in electronic form (in which case the check may be transferred electronically and/or viewed on a display screen). In either case, PC 200 is provided with various indicia, including a tracking code 210, a PC designation 220, a merchant logo 230, an issuer's name 240, and other indicia, as illustrated in FIG. 2.

Tracking code 210 of PC 200 can be an alphanumeric code that can include information such as a bank or issuer's routing number, as well as the customer's account number. PC designation 220 may be any suitable indicia that allows parties, such as the customer, merchant, authorizing authority, depositor, and/or issuer, to easily recognize that the financial instrument is a PC. PC designation 220 can be, for example, an alphanumeric code, bar code, diagram, and/or watermark identifying a particular merchant. There may also be a merchant logo 230 on PC 200. Logo 230 can be used as a designation code or for easy association with one or more merchants that are partnered with the issuer as part of the VSR.

In accordance with an embodiment of the invention, PC 200 also may include the issuer's name 240, as illustrated in FIG. 2. In accordance with another embodiment of the invention, the name of a merchant may occupy a “Pay to the Order of” line 250 of PC 200 to specifically limit use of the PC to financial transactions with the designated merchant. Further, a money amount line 260 can be provided on PC 200 and filled in for a predetermined amount to limit the value or transaction amount of the PC. Alternatively, money amount line 260 may be left open and later filled in by customer 130 to make a transaction in accordance with the terms and restrictions of PC 200.

In accordance with yet another embodiment of the invention, PC 200 can be structured such that it is only redeemable for a specific good or service, such as a dishwasher, a tennis racket, an oil change, or carpet cleaning, to name a few examples. The money amount line 260 may be filled in the appropriate transaction amount and a memo line 280 could be filled in to identify the specific good or service for which PC 200 is redeemable. Also, consistent with other embodiments of the invention, PC 200 can be set to expire on a predetermined date, after which the PC is no longer valid. For this purpose, a date expiration line 270 may include indicia indicating the expiration date of the PC. Alternatively, PC 200 may have an agreed-upon life time that is indicated to customer 130 when the PC is issued, or the expiration date for a PC can be left open.

FIG. 3 illustrates an exemplary flowchart for issuing partnership checks (PCs), in accordance with an embodiment of the invention. As illustrated in FIG. 3, one or more merchants 120 are identified for forming a VSR with the issuer 110 (step 310). The VSR may be structured such that issuer 110 agrees to issue PCs (such as PC 200) to one or more customers 130, whereby the PCs are redeemable with a specific merchant 120 and/or have a predetermined value. VSRs can be created either by an issuer approaching one or more merchants, or by one or more merchants approaching an issuer. As mentioned, merchant 120 can be any type of merchant. For illustrative purposes, merchants can be national chain stores, service shops, transportation merchants, and/or merchants dealing with food.

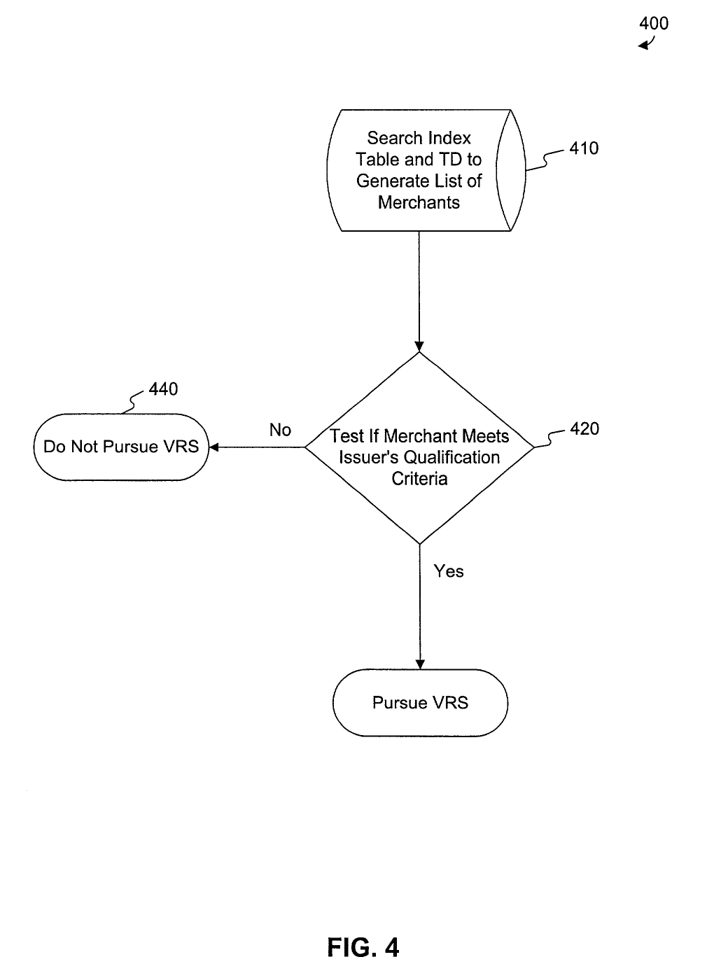

In order to identify merchants for VSRs, processor 116 may be used by issuer 110. For example, processor 116 may be configured to compare or analyze information from index table 112 and transactional database 114. Processor 116 may also be configured to analyze information concerning customers or merchants from external databases or sources (such as credit and/or financial information). Such an analysis may be made by processor 116 to determine whether particular merchants meet certain merchant qualification criteria of issuer 110 for a VSR. The merchant qualification criteria may include various criteria, such as geographic location of the merchant, number of merchant locations, brand recognition or goodwill of the merchant, popularity of the merchant among current customers of issuer 110, average price of goods or services offered by the merchant, and other qualification criteria. Further examples of merchant qualification criteria are described below in connection with the embodiment of FIG. 4.

After identifying a merchant for a VSR, the type of PCs to associate with each merchant is determined (step 320). The type of PC to be issued may be determined by the issuer alone or in combination with the merchant who has agreed to enter into the VSR with the issuer. As indicated, PCs may be structured so that they are only redeemable for specific goods or services, or so that they have a fixed value. Alternatively, PCs may be implemented such that the have an open value within a set amount determined by the customer's available credit or balance. Other terms and conditions of the PCs may be made by the issuer and/or merchant. In one embodiment of the present invention, the PC can fall within the terms of the issuer/customer agreement. In another embodiment, the PC can be issued with special promotional terms, which may include, for example, a rate incentive or merchant discount.

In order to determine the type of PC, processor 116 can be configured to assist in identifying which type of PC should be associated with each merchant. In an embodiment, processor 116 can identify the business type of a particular merchant 120. Processor 116 can then select appropriate types of PCs for that business type that would yield the greatest profit potential for both issuer 110 and merchant 120. The selection can be based on past purchasing behavior associated with that type of business. For example, if merchant 120 is a department store, past purchasing behavior may suggest that a PC providing a percent off or a fixed dollar amount may be yield the greatest potential. Processor 116 may be programmed to select a PC type, or processor 116 may output a set of PC types which issuer 110 and/or merchant 120 can use as suggestions.

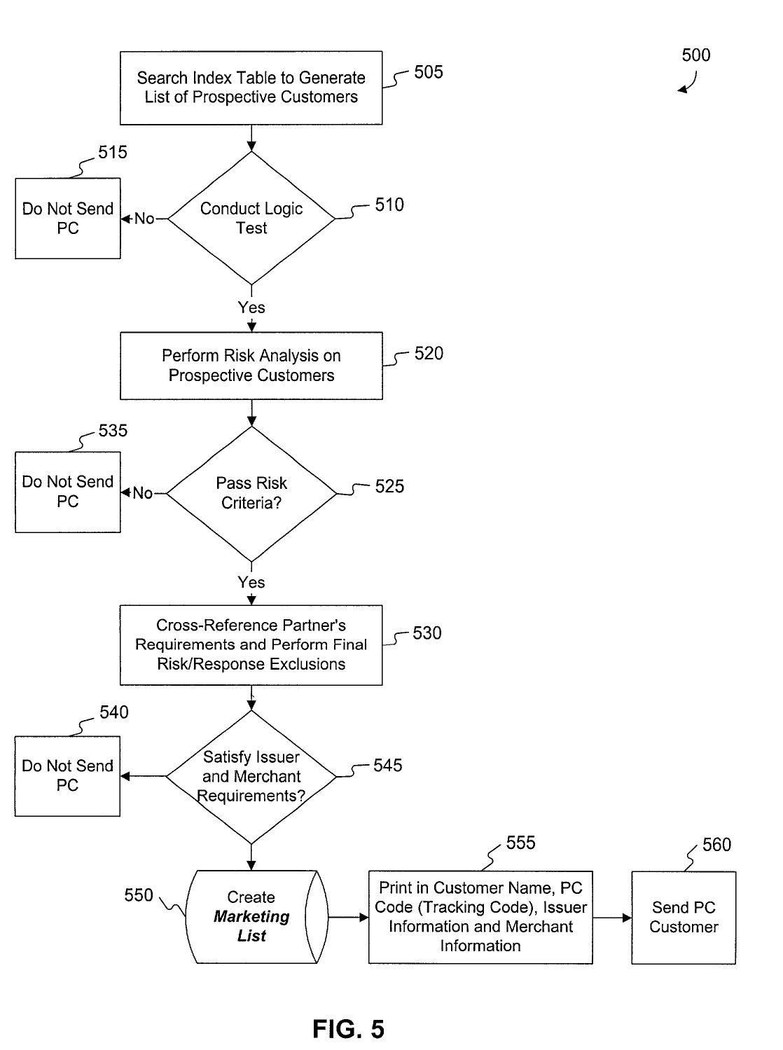

Referring again to FIG. 3, after determining the type of PCs for each merchant, customers are identified that qualify for the PCs (step 330). To identify a list of qualifying customers, processor 116 can be configured to identify existing or prospective customers of issuer 110 that meet a set of customer qualification criteria. As described below with reference to the embodiment of FIG. 5, the customer qualification criteria may include customer criteria set by the issuer and/or set by the merchant. The customer qualification criteria may include criteria such as the customer's probability of default, the customer's financial strength and ability to pay off a the debt if credit is extended. Customer criteria may also include such things as the customer's home or property ownership status; the customer's length of employment with their current employer; the customer's outstanding debt in relation to his/her annual income; and/or the customer's history of paying his/her debts on time. Other customer criteria may include the customer's past spending habits as evaluated from transactional database 114.

Once a list of qualifying customers are identified, the PCs are issued to qualifying customers (step 340). For example, using communication channels 150, issuer 110 can send PCs (such as PC 200) to customers 130 that satisfy the certain customer qualification criteria. When issuing PCs to customers 130, issuer 110 may include information concerning the terms and conditions of the PCs (such as use, value, expiration date, etc.). With the issued PCs, customers 130 can make financial transactions with particular merchant(s) 120. These transactions will be debited to the customer's financial account that is established with issuer 110.

Turning now to FIG. 4, an exemplary flowchart is provided for illustrating how VSRs can be created, in accordance with an embodiment of the present invention. Initially, a list is generated of potential merchants for a VSR (step 410). As part of this process, issuer 110 may use processor 116 to search index table 112 and transactional database 114 to generate a list of merchants. In one embodiment of the present invention, processor 116 may generate a list of each merchant in index table 112 and TD 114. In another embodiment, processor 116 may generate a list of merchants meeting a set of minimum threshold characteristics. Processor 116 may search for merchants that have, for example, multiple locations, or those that offer certain product, or other characteristics determined by issuer 110.

After the list of potential merchants is generated, a determination is made whether each merchant meets certain qualification criteria of the issuer (step 420). In accordance with an embodiment of the invention, processor 116 can be configured by issuer 110 to analyze the list of merchants. Such an analysis may be performed by processor 116 to determine if a merchant meets the qualification criteria of the issuer. The issuer's qualification criteria for a merchant may be based on numerous factors. For example, factors that processor 116 can consider may include quantitative factors such as, historical data of each merchant's quick ratio (i.e., a measure of the liquidity of a business, which can include a measure of cash plus short-term investments and receivables divided by current liabilities), times-interest-earned ratio, debt ratio, years in existence, geographic location, or number of locations. In addition, non-quantitative factors can be considered as well, by assigning each non-quantitative factor a numerical value. For example, processor 116 can consider a merchant's advertising and/or marketing expenditures, brand recognition, reputation with its customers, as well as the merchant's developed goodwill.

In accordance with another embodiment of the invention, processor 116 can use a statistical analysis (such as a regression analysis or multiple discriminant analysis) to generate a criteria value for each merchant analyzed at step 420. The criteria value may be an objective measure for comparing different merchants, each having multiple attributes (such as quantitative and non-quantitative factors). By comparing the criteria value for a particular merchant to a reference value set by issuer 110, processor 116 can determine if the particular merchant meets the issuer's qualification criteria.

In accordance with yet another embodiment of the invention, processor 116 may also analyze index table 112 and transactional database 114 (as well as external databases or resources, if needed) to determine a list of competitors for particular merchants. In such a case, merchants that meet the issuer's qualification criteria may be compared with the list of competitors (e.g., as part of step 420) to ensure that the merchant is not a competitor with another merchant (who has a pre-existing VSR or other relationship with issuer 110, or who has a higher criteria value). Merchants that pose conflicts may be excluded so that they are not approached for a VSR by issuer 110.

Merchants that satisfy the issuer's qualification criteria (step 420; Yes), may be pursued as a VSR partner by issuer 110 (step 430). Merchants, however, that do not satisfy the issuer's qualification criteria (step 420; No), will not be pursued for a VSR (step 440). For qualifying merchants 120, issuer 110 may approach the merchant to seek approval of the proposed VSR. As part of this process, issuer 110 may provide merchant 120 information concerning the terms of the proposed VSR and PCs for customers. Alternatively, issuer 110 may solicit merchant 120 to offer proposals for the VSR and PCs. Once a VSR is established between issuer 110 and merchant 120, PCs may be generated and issued to customers. By way of non-limiting examples, a PC can be sent to customers by direct mailing, as a separate mailing or with the customer's monthly statements of the account balance.

In accordance with an embodiment of the present invention, PCs (such as PC 200) can include an incentive to induce customer 130 to conduct a transaction with merchant 120 using the PC. This incentive can be an economic benefit, such as a reward or discount. In certain embodiments, customer 130 may pay a lower cost for goods or services purchased with the PC, or customer 130 may receive a discount of some form. In addition, in certain embodiments, issuer 110 and merchant 120 may share the cost of the incentive.

In certain embodiments, the incentive can be applied at the time of the transaction. Examples of the types of incentives applied at the time of transaction include: a discount on purchases made by customer 130 at merchant 120 either as a percent off of the total purchase amount, or a percent discount on particular items purchased by customer 130; and a “two-for-one” option for purchases made with the PC, or other similar type of bulk purchasing incentive. Additionally, as an incentive, use of a PC by customer 130 can yield increased savings when redeemed at designated times, or at designated merchant 120 locations.

In accordance with additional embodiments of the invention, the incentive associated with a PC can be applied after the transaction takes place. For example, customer 130 may receive a rebate or discount on the amounts credited to their accounts. Additionally, when a PC is used, issuer 110 can apply credit towards awards to be chosen later by customer 130. Such awards may be granted based on a point system (e.g., with points awarded for each use of a PC) or on a dollar-per-dollar basis (e.g., based on the dollar amount of each PC transaction).

Consistent with additional embodiments of the invention, HENDERSON advertisements or informative inserts about a merchant 120 can accompany a PC when it is issued to customers 130. Such inserts can include information about, for example, the merchant, products that the merchant sells, or any information the merchant may want to relay. For example, merchants may want to provide a list of locations to inform customers of the merchant's different locations or the various products or services offered by the merchant. Thus, inserts can provide customers with useful details about the merchant.

The decision about the type of incentive included with a PC may be based on a number of factors, including structure incentives that maximize the profit for both issuer 110 and merchant 120. In accordance with embodiments of the invention, such a decision can be made by estimating the effect the incentive will have on sales, average collection periods, bad debt losses and other credit considerations. Issuer 110 and merchant 120 can also determine the effect the use of a PC will have on their investment in accounts receivable. Similarly, issuer 110 and merchant 120 can determine the effect the use of a PC will have on their pre-tax profit. If a PC having a particular incentive is determined to increase profit, then that PC should be made available, unless it is judged to unsatisfactorily increase the acceptable risk of issuer 110 or merchant 120.

The decision of whether to issue a PC to a customer and if so, for how much and what type, can be subjective or objective. Objective decisions can be based on a logic test or a statistical method, such as a multiple discriminent analysis or a multiple regression analysis.

FIG. 5 is an exemplary flowchart for choosing customers to issue partnership checks to, in accordance with an embodiment of the invention. In the embodiment of FIG. 5, a logic test is employed for selecting customers. The logic test may be configured to test for a set of customer criteria specified by issuer 110, as well as a set of customer criteria specified by merchant 120. For example, a list of prospective customers may first be generated (step 505). This may be achieved by configuring processor 116 to search index table 112 and transactional database 114 for prospective customers. In one embodiment of the present invention, processor 116 may generate a list of very customer in index table 112 and TD 114. In another embodiment, processor 116 may generate a list of customers meeting a set of minimum threshold characteristics. Processor 116 may search for customers that have, for example, accounts in good standing, or that show a pattern of prompt payment, or those customers that have at least a particular level of credit, or other characteristic identified as important by issuer 110 or merchant 120.

After the list of prospective customers is generated, the logic test is conducted on each prospective customer (step 510). As indicated above, a logic test may be applied to determine if a prospective customer satisfies criteria set by issuer 110 and/or merchant 120. In accordance with an embodiment of the invention, the logic test may be performed by processor 116 to test various criteria such as: the prospective customer's address relative to the merchant's location; the prospective customer's spending habits; or whether the prospective customer has transacted with a predetermined set of merchants. The logic test can also be used to determine if a prospective customer has used convenience checks before to make purchases from merchant(s), or if a prospective customer has used other products of issuer 110 with merchant(s). If a prospective PC customer does not pass the logic test (step 510; No), the prospective customer is removed from consideration and may not be sent a PC (step 535). Alternatively, the logic test may suggest that the customer is suited for different products of issuer or merchant.

For each prospective customer that passes the logic test (step 510; Yes), additional processing may be performed. For example, a risk analysis may be performed on each prospective risk to assess the risk of offering a PC to the customer (step 520). As part of this risk analysis, processor 116 may screen and analyze the prospective customer's financial history. The results of the risk analysis may indicate whether a prospective PC customer provides a favorable risk versus return for both issuer 110 and merchant 120. For instance, a prospective PC customer may carry a large balance with issuer 110, indicating a likelihood of using a PC and thereby increasing his/her financial account balance held by issuer 110. However, the prospective PC customer may also continually be delinquent on payments, which may present an unwanted degree of risk to the partnership or VSR.

If a prospective customer does not pass the risk criteria (step 525; No), then the prospective customer is removed from consideration and will not be sent a PC (step 535). However, if a prospective customer passes the risk analysis (step 525; Yes), then the prospective customer may be further tested and cross-referenced against a set of criteria specified by the merchant (step 530). Cross-referencing can be used to ensure customers who meet the strategic needs of the merchant are targeted. In an alternative embodiment, the merchant may require that customer who have not purchased from the merchant be sent PC. In this case, the incentive would be used to induce new customers to visit the merchant. In particular, the parties to the VSR may establish various customer criteria for prospective PC customers. Thus, in addition to satisfying issuer's 110 criteria (such as acceptable risk versus return criteria), a prospective customer may also be required satisfy criteria specified by a merchant (such as criteria indicating the likelihood that the customer will use the PC or purchase specific goods or services from the merchant). Accordingly, each prospective customer may be further tested and cross-referenced against a set of criteria specified by the merchant to perform further risk and/or response exclusions. A final risk/response exclusion can be used before sending the PC to confirm the initial risk assessment has remained valid.

Prospective customers that do not satisfy the criteria or requirements of issuer 110 and merchant 120 (step 545; No) are removed from consideration and not sent a PC (step 535). However, prospective customers that do satisfy the criteria of both the issuer and merchant (step 545; Yes) are grouped to create a marketing or mailing list (step 550). The marketing or mailing list represents the group of customers who will be sent PC's. For each customer on the list, a specific PC is generated (step 555). For printed PCs (such as PC 200 of the embodiment of FIG. 2), this process may include printing the customer's name on the PC, together with other indicia such as a PC tracking code 210, a PC designation 220, the merchant's logo 230, the issuer's name 240, and/or money value of the PC. After generating the PCs, issuer 110 sends the PCs to the customers 130 designated on the marketing list (step 560).

In accordance with an embodiment of the invention, processor 116 can analyze a set of predetermined factors to determine which customers in the generated prospective customer list (see step 505) meet issuer's 110 and/or merchant's 120 customer qualification criteria. When conducting a statistical analysis (such as multiple discriminant analysis or multiple regression analysis), the dependent variable can be, for instance, the probability of default, and the independent variables can be various factors associated with the customer's financial strength and ability to pay off the debt if credit is extended. For example, if issuer 110 evaluates a customer's credit quality, then the independent variables in the credit scoring system could be such factors as: does the customer own his/her own home; how long has the customer worked at his/her current job; what is the customer's outstanding debt in relation to his/her annual income; and/or does the customer have a history of paying his/her debts on time.

Consistent with the principles of the invention, the use of such a statistical analysis permits a customer's credit quality to be expressed in a single numerical value, rather than a subjective assessment of various factors. By using a credit-scoring system, issuer 110 can evaluate multiple customers in many different locations and apply equal standards to all customers. Thus, issuer 110 can make a more informed decision based on risk factors about whether to issue a PC and what type of PC to issue qualified customers.

As discussed above, in addition to using index table 112 and transactional database 114, issuer 110 can also obtain information about customers from external sources or databases. For instance, issuer 110 can contact a credit association that compiles and communicates information about a customer's past performance. These associations typically record payment records of different debtors, the industries from which they are buying, and the geographic areas in which they are making purchases. Similarly, issuers can obtain information from credit-reporting agencies, which collect credit information and sell it for a fee. Credit-reporting agencies provide factual data that can be used in a credit analysis.

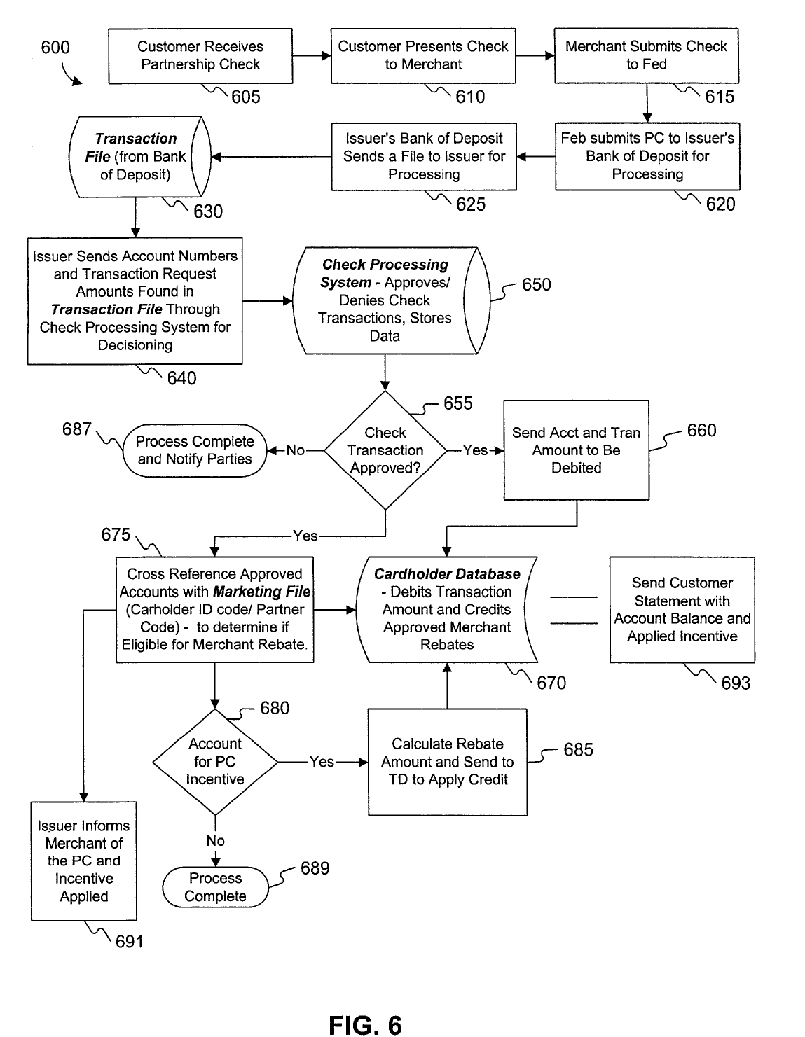

Turning now to FIG. 6, an exemplary flowchart is provided for making a transaction using a PC (such as PC 200), in accordance with an embodiment of the invention. As illustrated in FIG. 6, customers 130 receiving PCs (step 605) may present and use the PC to purchase goods or services from a particular merchant 120 (step 610). After identifying the PC as a partnership check (e.g., by viewing or inspecting the indicia on the PC), the merchant may process the PC by submitting it to a financial authority (step 615). With reference to FIG. 1, merchant 120 using communication channel 150 may submit the PC to a financial authority 140, which may be the Federal Reserve Bank of the United States or another agreed upon financial authority.

As further illustrated in FIG. 6, financial authority 140 then submits the PC to the bank of deposit for the issuer 110 (step 620). The issuer's bank of deposit, which may be a bank or other financial institution, performs initial processing on the PC. This initial processing may include sending a file or notice to issuer 110 detailing the use of the PC by customer 130 (step 625). This file or notice made sent and received by issuer 110 as a transaction file (step 630). Using the transaction file, issuer 110 extracts the account numbers and PC transaction request amounts and routes this information through a check processing system for decisioning (step 640).

In an embodiment of the present invention, processor 116 can accomplish the initial processing on the PC as well as extracting the account numbers, request amounts, and routing for check PC processing. In an embodiment of the present invention, processor 116 can also use a high speed reader/sorter to process the checks by reading and sorting each PC according to the information printed on the PC. For example, PCs can be read and sorted according to a tracking code (such as tracking code 210 of PC 200). In some cases, PCs may be rejected from the high speed reader/sorter because the tracking code is be unreadable. In such cases, rejected PCs can be manually handled and/or corrected. A balance can then be computed. Sorted PCs and a list of their amounts can be sent to transactional database 114 so that the appropriate accounts can be debited or posted.

Referring again to FIG. 6, check processing system reviews the PC transactions from issuer 110 and determines whether to approve or deny each transaction (step 650). During this process, check processing system may also store or record data about each of the used PCs. This stored information can be sent back and used by issuer 110 to update transactional database 114 and determine which customers to send additional PCs. For each PC transaction that is approved (step 655; Yes), information concerning the customer's account number and PC transaction amount are sent to issuer 110 (step 660). Issuer 110 may apply this information (for example, using transactional database 114) to debit or post the transaction amount to the PC customer's account and credit the customer's account for any incentive or approved merchant rebate (step 670).

In an embodiment of the present invention, the financial account of customer 130 held by issuer 110 can be a credit card account, a checking account, a money market account, a direct debit account, or another type of financial account set up to transact credits and debits. In certain embodiments, the PC transaction amount debited from the customer's account can be charged the same interest rate as other balances carried, or the rate of interest can be specific to the PC. In other embodiments, the PC incentive may include a more favorable interest rate charged to balances accumulated using PCs. In embodiments where the financial account is a savings, direct debit or checking account, PC transactions can be debited or posted similar to debit or check transactions.

In addition, for each PC transaction that is approved (step 655; Yes), the used PC can be cross-referenced against a marketing file to determine if the customer's account is eligible for a merchant rebate or other incentive (step 675). In accordance with an embodiment of the invention, a marketing file may be provided that contains information (designating by, for example, a customer's ID code, a PC code and/or merchant code) to indicate the incentive (if any) that is applicable to each used PC. Information from this cross-referencing is used to instruct issuer 110 whether credits should be applied to the customer's account (step 670) and to indicate whether an accounting of the PC incentive is required (step 680). The result of the cross-referencing may also be used to trigger notification by issuer 110 to merchant 120 that the PC was approved and indicate if the incentive was applied to the transaction (step 691).

If an accounting of the PC incentive is necessary (step 680; Yes), then the incentive amount may be calculated by issuer 110 based upon the terms of the PC used by customer 130 (step 685). The amount of the incentive is then credited to the customer's account (using, for example, transactional database 114) (step 670). If the PC was not approved (step 655; No), then processing is completed and the issuer 110 and merchant 120 are notified of the denial of the PC (step 687). Similarly, if the terms of the PC incentive are not met and the PC is not eligible for a PC incentive (step 680; No), then the process is completed and the parties are also notified (step 689).

In an embodiment of the present invention, if the PC is not approved as a partnership check, issuer 110 may still honor the face value of the check and credit merchant 120 and debit customer 130, but customer 130 may not receive the incentive provided in the issued PC. In other embodiments, if the PC is not approved, issuer may seek immediate collection from customer 130 or take steps to investigate a possible fraud.

As indicated above, after cross-referencing (step 675) issuer 110 may inform merchant 120 of the PC use and the incentive applied (step 691). Using this information, issuer 110 and merchant 120 can apportion the cost of the PC. At step 693, customer 130 can also be sent a statement of his/her account balance with issuer 110 and information indicating PC use and the applied incentives (if any).

In certain embodiments, using PCs provides customers 130 with economic advantages. One advantage to the customer for using a PC is the incentive awarded. Another advantage is that the PC can save a customer time. For example, time is saved in deciding where to shop because the PC can be redeemable at a specific merchant. Customers can also save time managing their money because they have a more accurate accounting of their spending, as issuer's include a list of PC spending in the periodic statements to the customer.

In certain embodiments, PC provide economic advantages to merchant 120. For example, merchants may benefit from increased shopping by customers and overall profit. Profit can increase when more sales are made as customers are induced to transact with merchant 120 because of the incentive included with a PC. In addition, because PCs are pre-approved, time is saved at checkout and transactions take less time allowing the employees to handle more customers. Further, sales attendants need no additional training to learn how to process PCs. Also, pre-approval of PCs reduces fraud, thus providing additional security to the merchant at no additional cost. With PCs, merchants may not pay a transaction or interchange fee, contrary to credit card purchases. Issuers and merchants also build goodwill with customers over time because customers begin to associate issuers and merchants as ‘partners.’

In other embodiments of the present invention, issuer 110 can use mailings to attract new customers. In this case, issuer 110 may search transactional database 114 for potential customers to whom information about merchant 120 can be sent. This can be accomplished by issuer 110 analyzing information about spending habits of customers 130 in transactional database 114 and determining those customers who have not shopped at merchant 120, but who show a statistical likelihood of shopping with an entity such as merchant 120. Once these potential customers are identified, issuer 110 may send a mailing containing information about merchant 120, and in some instances, include promotional inserts, such as coupons, to induce potential customers to visit merchant 120. Alternatively, issuer may send these potential customers a potential PC. A potential PC can be a document in resembling a PC, whereby certain actions must be taken by the potential customer for the potential PC to mature into a PC. For instance, the potential customer must present the potential PC to a bank for deposit or the potential customer may need to call and inform issuer 110 of the potential customers intension to accept and use the potential PC. In any case, the potential PC may not become a PC until some confirmation action is taken by the potential customer to indicate to issuer 110 that the potential customer intends to use the instrument.

In certain embodiments, there are economic advantages to issuer 110 as customers build their account balance. For example, with the PCs customers will use more of the issuer's financial products and services.

In other embodiments, economic transactional efficiencies arise between the issuer and partner (i.e., merchant). Issuers and partners can share in any proportion costs of the PC, such as incentives to customers, advertising, printing, and mailing. Economies of scale allow both parties to gain at less expense to either party.

In still other embodiments, PCs can enhance informational efficiencies for the parties. Partners benefit both externally and internally. Externally, PCs are an expanded form of advertising where costs are shared between the issuer and the merchant. In certain embodiments, merchants benefit internally as well. For example, lower transaction costs result for the partner because of better inventory controls. Knowing the expected use of issued PCs allows the partner to plan ahead. Partners internalize this information to control inventory and make forecasts about what products will be needed.

In still other embodiments, lower transaction costs for customers result from receiving information about partners. For example, customers can save time and money by receiving information that helps them determine where to buy certain products.

In accordance with another embodiment of present invention, transaction costs are reduced for issuers as information in transactional database 114 is updated. Such updates help the issuer target future users of PCs, thus providing “effective prospecting” of customers. Again, because costs are shared between issuers and partners, overall cost to the issuer is lowered.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for issuing partnership checks to customers, comprising:
analyzing a group of merchants based on a set of merchant qualification criteria to identify a merchant for associating with a partnership check;
creating the partnership check such that the partnership check is redeemable with the identified merchant; and
sending the created partnership check to a set of customer.

2. A method for issuing partnership checks according to claim 1, further including the step of:
sending the partnership check only to customers meeting customer qualification criteria.

3. A method for issuing partnership checks according to claim 1, wherein the merchant qualification criteria is analyzed using a statistical analysis method.

4. A method for issuing partnership checks according to claim 3, wherein the statistical analysis method considers quantitative and non-quantitative factors.

5. A method for issuing partnership checks according to claim 1, further including the step of:
providing an incentive with the partnership check to induce the set of customers to use the partnership check.

6. A method for issuing partnership checks according to claim 5, wherein the incentive provides an economic benefit to the customers using the partnership check.

7. A method for issuing partnership checks according to claim 5, further comprising applying the incentive at the time the partnership check is used by the customers.

8. A method for issuing partnership checks according to claim 7, wherein the incentive is a discount applied to a transaction amount.

9. A method for issuing partnership checks according to claim 5, wherein the incentive is applied after the transaction using the partnership check takes place.

10. A method for issuing partnership checks according to claim 5 further including sending informative inserts to the set of customers with the partnership check.

11. A method for issuing partnership checks according to claim 2, further including:
providing an economic incentive with the partnership check for customers that use the partnership check, wherein the type of economic incentive is determined based on maximizing profit for an issuer of the partnership check and the merchant.

12. A method for issuing partnership checks according to claim 2 wherein the customer qualification criteria is based on a set of customer criteria specified by an issuer of the partnership check and a set of customer criteria specified by the merchant.

13. A method for providing partnership checks to customers, the partnership checks being issued by an issuer, said method comprising:
forming a value sharing relationship with at least one merchant;
generating partnership checks that are redeemable with the at least one merchant, each of the partnership checks including printed indicia that is indicative of a predetermined transaction amount; and
providing an incentive with each partnership check, wherein the incentive extends to customers that use the partnership check.

14. A method for generating a partnership check according to claim 13 further comprising:
crediting a financial account of a customer in accordance with the incentive provided with the partnership check.

15. A method for generating a partnership check according to claim 13 further comprising:
authenticating a partnership check when a customer redeems the partnership check with the at least one merchant; and
applying a credit to a financial account of the customer for each redeemed partnership check that is authenticated.

16. A method for generating a partnership check according to claim 13 wherein the incentive provides an economic benefit to the customer and further wherein the cost of the incentive is shared between the issuer and the merchant.

17. A method for generating a partnership check according to claim 13 further comprising:
sending partnership checks to customers with informational material.

18. A method for providing partnership checks, said method comprising:
generating a list of prospective merchants;
analyzing the list of prospective merchants based on a set of merchant qualification criteria to form a set of merchants;
generating a list of prospective customers;
analyzing the list of prospective customers based on a set of customer qualification criteria to form a set of customers; and
issuing partnership checks to the set of customers, wherein each of the partnership checks includes an incentive that extends to customers that use the partnership check as part of a financial transaction with the set of merchants.

19. The method of providing partnership checks according to claim 18 wherein generating a list of prospective customers includes generating a list of prospective customers based on an transactional database containing financial information about the prospective customers.

20. The method of providing partnership checks according to claim 18 wherein analyzing the list of prospective customers comprising analyzing the list of prospective customers based on a set of customer qualification criteria specified by the set of merchants.

21. The method of providing partnership checks according to claim 18 further comprising:
authenticating a partnership check when a customer redeems the partnership check with the at least one merchant; and
applying a credit to a financial account of the customer for each redeemed partnership check that is authenticated.

22. A partnership check system, comprising:
means for analyzing a group of merchants based on a set of merchant qualification criteria to identify a merchant for associating a partnership check;
means for creating the partnership check such that the partnership check is redeemable with the identified merchant; and
means of sending the created partnership check to a set of customers.

23. A partnership check system according to claim 22 further wherein the means for analyzing the group of merchants comprises means for performing an analysis of the group of merchants based on a statistical analysis.

24. A partnership check system according to claim 23 wherein the statistical analysis considers quantitative and non-quantitative factors.

25. A partnership check system according to claim 22 further comprising:
means for inducing the set of customers to use the partnership check.

26. A partnership check system according to claim 25, wherein the means for inducing the set of customers to use the partnership check includes means for providing an economic incentive with the partnership check that extends to customers that use the partnership check.
